(19) United States
(12) Patent Application Publication
(10) Pub. No.: US 2026/0353481 A1
(43) Pub. Date: Nov. 5, 2026

(54) ROUTER DEVICE AND LOCALIZED NETWORK MANAGEMENT METHOD THEREOF

(71) Applicant: ASUSTeK COMPUTER INC., Taipei City (TW)

(72) Inventors: Kai-Chiao Chang, Taipei City (TW); Ten-Long Dan, Taipei City (TW)

(73) Assignee: ASUSTeK COMPUTER INC., Taipei City (TW)

(21) Appl. No.: 19/658,734

(22) Filed: Apr. 27, 2026

(30) Foreign Application Priority Data
Apr. 30, 2025 (TW) 114116247

(51) Int. Cl. H04W 76/11; H04W 76/14

(52) U.S. Cl. CPC H04W 76/11; H04W 76/14

(57) ABSTRACT

A router device and a localized network management method thereof are provided. The method adapted to the router device comprises the following steps. A device identifier is received. Based on the device identifier, connection information of a network device is obtained. Based on the connection information of the network device, the network device is bound to the router device, and a connection between the network device and the router device is established. Based on the connection with the network device, device operation information of the bound network device is received. The operation information of the network device is stored, and remote management and network control operation is performed on the bound network device.

### CROSS-REFERENCE TO RELATED APPLICATION

This application claims the priority benefit of Taiwan application serial no. 114116247, filed on Apr. 30, 2025. The entirety of the above-mentioned patent application is hereby incorporated by reference herein and made a part of this specification.

### BACKGROUND

### Technical Field

The disclosure relates to a router device and a localized network management method thereof.

### Related Art

Modern enterprises and small businesses typically manage multi-brand, multi-model, cross-regional network devices remotely through cloud management systems. However, such centralized management relies on third-party cloud servers, where all device configurations and traffic data need to be uploaded to external platforms. As a result, enterprises are unable to fully control their own information, thereby increasing the risks of data leakage and unauthorized access.

In addition, existing cloud-based management systems also have limitations in VPN configuration. Most systems only support VPN connections for individual network device, making inter-site connections within the enterprise more complex, and even requiring the deployment of additional VPN solutions. Moreover, these cloud-based systems heavily depend on internet connectivity. When the connection to the third-party cloud server is interrupted, administrators will be unable to access or configure the network devices, affecting the stability of the enterprise network. Therefore, while cloud management improves operational convenience, it also introduces problems such as data security risks, insufficient management flexibility, and reliance on network connectivity. These issues make it difficult to meet the demands of applications requiring high levels of privacy and stability. Enterprises urgently need a more secure and flexible network management mechanism.

### SUMMARY

The disclosure provides a localized network management method, adapted to a router device, and includes the following steps. A device identifier is received. Connection information of a network device is obtained according to the device identifier. According to the connection information of the network device, the network device is bound to the router device, and a connection between the network device and the router device is established. According to the connection between the router device and the network device, device operation information of the bound network device is received. The device operation information is stored, and a remote management and network control operation is performed on the bound network device.

The disclosure also provides a router device, which comprises a transceiver, a storage device, and a processor. The processor is coupled to the transceiver and the storage device, and is configured to execute the following operations. A device identifier is received. Connection information of a network device is obtained according to the device identifier. According to the connection information of the network device, the network device is bound to the router device, and a connection between the network device and the router device is established. According to the connection between the router device and the network device, device operation information of the bound network device is received. The device operation information is stored, and a remote management and network control operation is performed on the bound network device.

Based on the above, in the embodiments of the disclosure, according to the device identifier associated with a network device, the router device confirms the binding relationship between the router device itself and the network device. After establishing a connection with the network device, the router device receives device operation information from the network device, and stores the device operation information of the network device. Thus, the router device performs a remote management and network control operation on the bound network device based on the recorded device operation information. Therefore, the device operation information of the network device does not need to be uploaded to and stored on third-party servers of the cloud management platform. Through the localized management mechanism of the router device, dependence on third-party servers of the cloud management platform is able to be effectively reduced, enhancing the real-time performance and privacy of data processing.

### BRIEF DESCRIPTION OF THE DRAWINGS

FIG. 1 is a schematic diagram of a localized network management system according to an embodiment of the disclosure.

FIG. 2 is a schematic diagram of a router device according to an embodiment of the disclosure.

FIG. 3 is a flowchart of a localized network management method according to an embodiment of the disclosure.

FIG. 4 is a flowchart of a localized network management method according to an embodiment of the disclosure.

FIG. 5 is a flowchart of a localized network management method according to an embodiment of the disclosure.

FIG. 6 is a schematic diagram of a management interface provided by a router device according to an embodiment of the disclosure.

### DESCRIPTION OF THE EMBODIMENTS

Some embodiments of the disclosure may be described in detail with reference to the accompanying drawings. The component symbols cited in the following description may be regarded as the same or similar components when the same component symbols appear in different drawings. These embodiments are only part of the disclosure and do not disclose all possible embodiments of the disclosure. Rather, these embodiments are merely examples of devices and methods within the scope of the patent application of the disclosure.

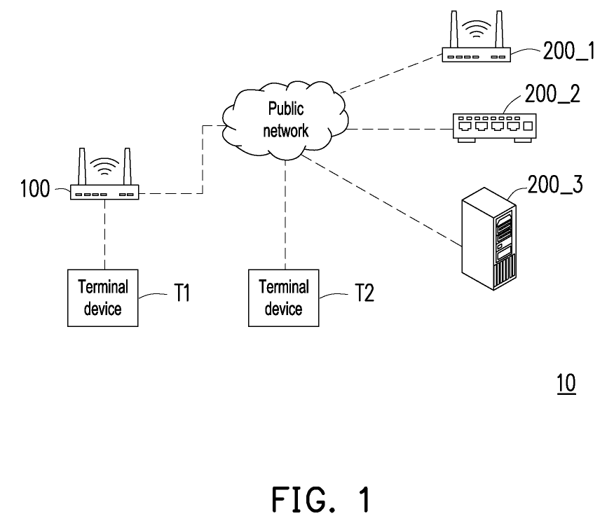

Referring to FIG. 1, which is a schematic diagram of a localized network management system according to an embodiment of the disclosure. The localized network management system 10 comprises a router device 100, a plurality of network devices 200_1 to 200_3, and a terminal device T1. In some embodiments, the terminal device T1 connects to a public network (for example, the Internet) through the router device 100. In some embodiments, the router device 100 connects to the Internet via an Internet Service Provider (ISP)'s modem or optical fiber converter. In some embodiments, the ISP's modem is integrated into the router device 100. The terminal device T1 connects to the router device 100 either wired or wirelessly. In some embodiments, the router device 100 is a wireless router compliant with Wi-Fi protocol, and the terminal device T1 establishes a connection with the router device 100 based on Wi-Fi protocol. In some embodiments, when the terminal device T1 establishes a wireless connection with the router device 100, the router device 100 uses 2.4GHz, 5GHz, 6GHz frequency bands or a combination thereof to communicate wirelessly with the terminal device T1. Alternatively, in some embodiments, the terminal device T1 connects to a physical port (for example, a Local Area Network (LAN) port) of the router device 100 via a cable.

In some embodiments, the terminal device T1 directly connected to the router device 100 or the terminal device T2 indirectly connected to the router device 100 is configured to access the management interface of the router device 100. The terminal device T2 indirectly connects to the router device 100 via a public network.

In some embodiments, the terminal device T1 and the terminal device T2 are, such as smartphones, tablet computers, laptop computers, desktop computers, etc., which is not limited in the disclosure. The terminal device T1 connects to the public network through connecting to the router device 100.

In some embodiments, the network devices 200_1 to 200_3 are wireless routers, switches, or access point (AP) devices, etc. These network devices 200_1 to 200_3 are responsible for different functions such as data forwarding and wireless signal coverage according to different application requirements. The network devices 200_1 to 200_3 are located at different geographical locations, for example, different offices, factories, branch companies, or remote sites. Although FIG. 1 illustrates with 3 network devices 200_1 to 200_3 as an example, the disclosure does not impose any limitations on the number of network devices.

In some embodiments, the router device 100 serves as a management server for managing the network devices 200_1 to 200_3. That is, the router device 100 serves as a management server for across regional networks, responsible for unified management of multiple network devices 200_1 to 200_3 located in different geographical areas. Furthermore, after binding the network devices 200_1 to 200_3 to the designated router device 100, the router device 100 records and monitors the device operation information and data analysis results of the device operation information of each network device 200_1 to 200_3 in real-time, such as connection status, data traffic, and operational performance, etc. Since the router device 100 is a router with network management functions, dependency on third-party cloud servers may be reduced, enhancing network security and privacy protection.

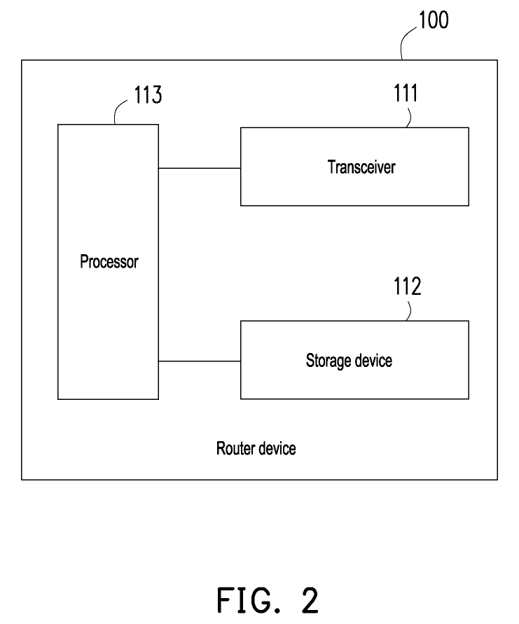

Referring to FIG. 2, which is a schematic diagram of a router device according to an embodiment of the disclosure. The router device 100 comprises a transceiver 111, a storage device 112, and a processor 113. The processor 113 is coupled to the transceiver 111 and the storage device 112.

In some embodiments, the transceiver 111 transmits and receives signals in a wireless or wired way. The transceiver 111 executes operations such as low-noise amplification, impedance matching, mixing, up or down frequency conversion, filtering, amplification, and similar operations. The router device 100 receives and send data through the transceiver 111. In some embodiments, the router device 100 also comprises an antenna (not shown).

The storage device 112 is configured to store files, instructions, codes, software modules and other data, which is any type of fixed or removable random access memory (RAM), read-only memory (ROM), flash memory or other similar devices, integrated circuits or combinations thereof.

The processor 113 is a programmable general-purpose or special-purpose microprocessor, Digital Signal Processor (DSP), programmable controller, Application Specific Integrated Circuits (ASIC), Programmable Logic Device (PLD), or other similar devices or combinations of these devices. The processor 113 executes code, software/firmware modules, instructions, etc. stored in the storage device 112 to implement the localized network management method of the embodiments of the disclosure.

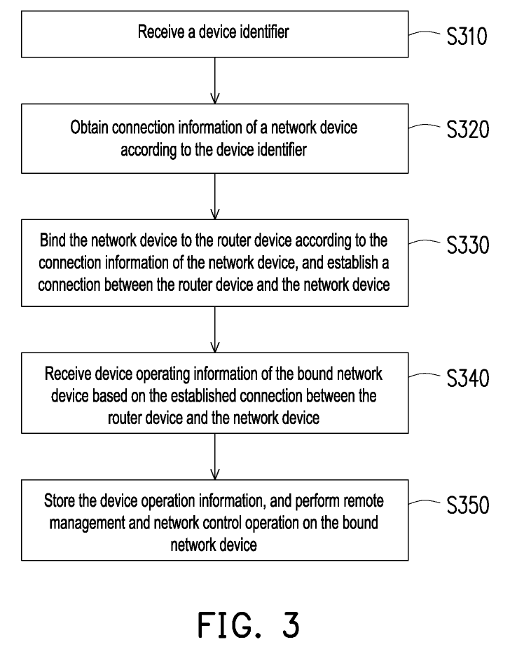

Referring to FIG. 3, which is a flowchart of a localized network management method according to an embodiment of the disclosure. Also referring to FIGS. 1 and 2, the method of this embodiment is applicable to the router device 100 of the localized network management system 10 in the above embodiment, and the detailed steps of the localized network management method of this embodiment will be explained below in conjunction with the various components in the router device 100 and the localized network management system 10.

In step S310, the processor 113 receives a device identifier. In various embodiments, the device identifier is a personal identifier number (Personal Identification number, PIN) code or a two-dimensional barcode (for example, QR code).

In some embodiments, when remotely binding the network device 200_1 through a client application (App), desktop utility program or management interface (Web Portal), the processor 113 uses a management interface to receive a PIN Code or QR Code input by the user to verify the legitimacy of the network device 200_1. In some embodiments, the device identifier is sent to the user through short message service (SMS) or electronic mail (Email), and the user manually inputs the device identifier at a management interface. The management interface is displayed by the terminal device T1 connected to the router device 100. Alternatively, the management interface is displayed by the terminal device T2 indirectly connected to (for example, through a public network) the router device 100.

In step S320, the processor 113 obtains connection information of a network device 200_1 according to the device identifier. The connection information of the network device 200_1 comprises MAC address (Media Access Control Address), IP address (Internet Protocol Address), connection type, and device hostname, etc.

In some embodiments, the processor 113 verifies the device identifier to obtain the connection information of the network device 200_1. In some embodiments, when the PIN Code received by the processor 113 passes verification, the processor 113 obtains the connection information of the network device 200_1. That is, the correct PIN Code corresponding to the network device 200_1 is generated by the router device 100, and verified by the router device 100.

In some embodiments, the processor 113 decodes the device identifier to obtain the connection information of the network device 200_1. In some embodiments, the processor 113 decodes the QR code to obtain the connection information of the network device 200_1. That is, the connection information of the network device 200_1 is encoded as a two-dimensional code or other type of graphical code, so that the processor 113 obtains the connection information of the network device 200_1 through decoding the device identifier.

In step S330, the processor 113 binds the network device 200_1 to the router device 100 according to the connection information of the network device 200_1, and establishes a connection with the network device 200_1. Specifically, after the processor 113 obtains the connection information of the network device 200_1, the processor 113 adds the network device 200_1 to a management list. And, the processor 113 establishes a remote connection with the network device 200_1 based on the connection information of the network device 200_1. Furthermore, the router device 100 establishes a cross-area connection with the network device 200_1 through a public network.

In some embodiments, the router device 100 establishes a VPN (Virtual Private Network) connection with the network device 200_1. In some embodiments, the processor 113 uses a secure communication protocol that can establish a secure encrypted channel to create a VPN connection between the router device 100 and the network device 200_1, the above secure communication protocol is IPSec (Internet Protocol Security), SSL VPN (Secure Sockets Layer Virtual Private Network), or WireGuard, etc. In this way, even if the network device 200_1 and the router device 100 are located in different geographical areas (such as remote offices, branch offices, etc.), they are able to still securely communicate with the router device 100 through a public network, ensuring the connection stability and data security between devices, and supporting cross-area management and remote operation. As can be seen, the router device 100 quickly establishes site-to-site VPN connections with multiple network devices. In some embodiments, the router device 100 is configured as a VPN server, which helps establish site to site VPN connections between network devices 200_1 to 200_3, to protect the data transmitted between these cross-regional network devices.

In step S340, the processor 113 receives device operation information of the bound network device 200_1 according to the connection with the network device 200_1. In some embodiments, the device operation information comprises device real-time status, network traffic data, device logs (Log) and security information, etc. The device real-time status comprises the number of device connections, processor load, memory usage, or other performance-related metrics. The network traffic data comprises upstream and downstream data traffic, packet loss rate, packet delay status, or other indicators of network performance. The device logs comprises error logs, connection records, or other types of log entries related to device operation. The security information comprises firewall configurations, unauthorized access alerts, or other security-related data. The network device 200_1 periodically reports device operation information. Alternatively, the network device 200_1 reports device operation information based on event triggers.

In step S350, the processor 113 stores the device operation information and performs a remote management and network control operation on the bound network device 200_1. Specifically, the processor 113 stores the device operation information of the network device 200_1 in the storage device 112. That is, the router device 100 records the device operation information of one or more bound network devices in the management list. From another perspective, in some embodiments, the router device 100 is configured with a central processor and information storage to implement remote management and control of multiple network devices.

In some embodiments, the router device 100 analyzes the device operation information of the network device 200_1 to perform network device management functions according to the analysis results. In some embodiments, the processor 113 displays the analysis results of the device operation information of the network device 200_1 in a graphical interface, allowing the administrator to quickly grasp the operating status of the network device 200_1. Alternatively, the router device 100 optimizes bandwidth allocation for the network device 200_1 according to the network traffic data of the network device 200_1.

In some embodiments, the router device 100 remotely restarts or remotely shuts down the bound network device 200_1. Alternatively, in some embodiments, the router device 100 controls the network device 200_1 to perform firmware updates to fix security vulnerabilities or improve performance.

In some embodiments, based on the terminal device T2 issues network device management instructions to the router device 100 via a public network, therefore remote management of the network device 200_1 is implemented by the router device 100. In some embodiments, the router device 100 performs backup of the device operation information of the network device 200_1.

It should be noted that the above embodiment uses the network device 200_1 as an example for explanation, but the router device 100 obtains device operation information of other network devices 200_2, 200_3 and performs remote management and network control operations on the bound network devices 200_2, 200_3 according to similar processes and operations.

Based on above, through simple and convenient operations, administrators bind network devices located in different geographical locations with the same router device, so that the router device can serve as a network management server for managing network devices. Based on this, by remotely and centrally managing multiple network devices through the router device, there is no need to dispatch network management personnel to different geographical areas to manage network devices. Additionally, the privacy data of these network devices will not flow into third-party servers, greatly enhancing data security and network security.

In some embodiments, the router device performs a verification process on the device identifier. When the device identifier is verified, the router device obtains the connection information of the network device. The device identifier comprises a personal identifier number (PIN) code generated by an authentication server.

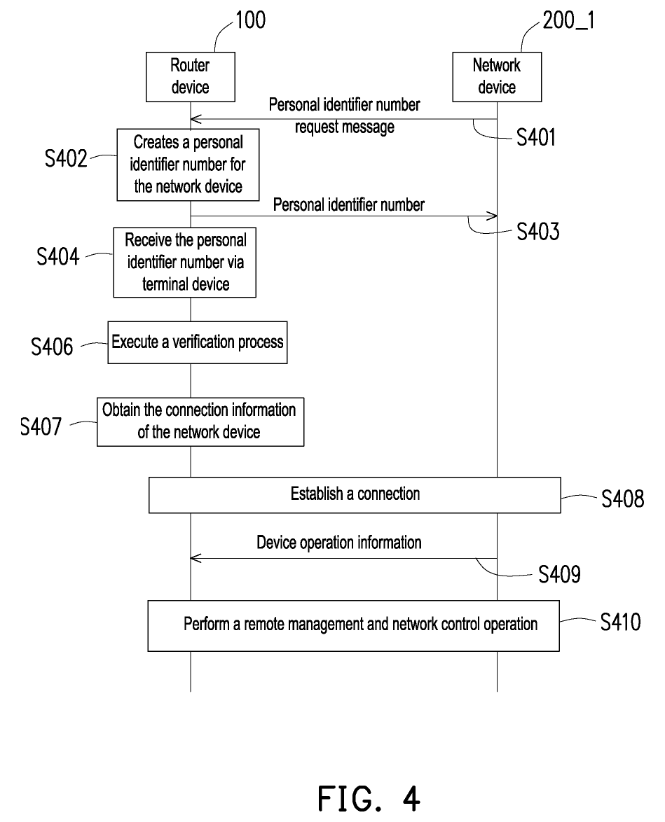

Referring to FIG. 4, which is a flowchart of a localized network management method according to an embodiment of the disclosure. In step S401, the network device 200_1 sends a personal identifier number request message to the router device 100 to request the router device 100 to generate a personal identifier number code. Specifically, the network device 200_1 calls a configured application programming interface (API) and request the router device 100 to provide a personal identifier number code via a public network. The network device 200_1 displays the personal identifier number code obtained from the router device 100 on the device management interface of the network device 200_1. The user enters the device management interface of the network device 200_1, and the network device 200_1 provides an operation option for generating a personal identifier number code to the user. When the user clicks on the above operation option, the network device 200_1 will send a personal identifier number request message to the router device 100.

In step S402, in response to receiving the personal identifier number request message, the router device 100 creates a personal identifier number code for the network device 200_1. In one embodiment, the personal identifier number code of the network device 200_1 is a temporary identifier with time effectiveness, ensuring it is only valid within a specific period. That is, the personal identifier number code created by the router device 100 is only valid during a designated time period. Alternatively, the router device 100 limits the number of times the personal identifier code can be used, for example, it may only be used once.

In step S403, the router device 100 sends the personal identifier number code to the network device 200_1. Thus, the user of the network device 200_1 obtains the personal identifier number code by logging into the device management interface of the network device 200_1. In some other embodiments, the router device 100 also sends the personal identifier number code of the network device 200_1 directly to the user, for example, through email or text message, etc.

In step S404, the router device 100 receives the personal identifier number code input by the user via terminal device T1 or terminal device T2. Furthermore, the user of the network device 200_1 sends the personal identifier number code of the network device 200_1 to the administrator via email or text message, so that the administrator can manually input the personal identifier number code to the router device 100 through terminal device T1 or terminal device T2 connected to the router device 100.

In step S406, in response to receiving the personal identifier number code input by the user, the router device 100 performs a verification process. In step S407, when the personal identifier number code input by the user is verified, the router device 100 obtains the connection information of the network device 200_1 corresponding to the successfully verified personal identifier number code. Specifically, the router device 100 determines whether the personal identifier number code sent by the router device 100 complies with predefined standards and whether the personal identifier number code is still within the valid period. The router device 100 compares whether the personal identifier number code input by the user matches the personal identifier number code previously generated for the network device 200_1. When the personal identifier number code sent by the router device 100 matches the personal identifier number of the network device 200_1, the router device 100 determines that the personal identifier number sent by the router device 100 passes verification. After the personal identifier number code is verified, the router device 100 obtains the connection information of the network device 200_1 corresponding to the successfully verified personal identifier number code.

In step S408, the router device 100, according to the connection information of the network device 200_1, mat bind the network device 200_1 to the router device 100, and establish a connection between the router device 100 and the network device 200_1. In step S409, the network device 200_1 sends device operation information to the router device 100. In step S410, the router device 100 stores the device operation information, and perform remote management and network control operations on the bound network device 200_1. The detailed operations of the above steps S408 to S410 is referred to in the previously described embodiment, which will not be repeated here.

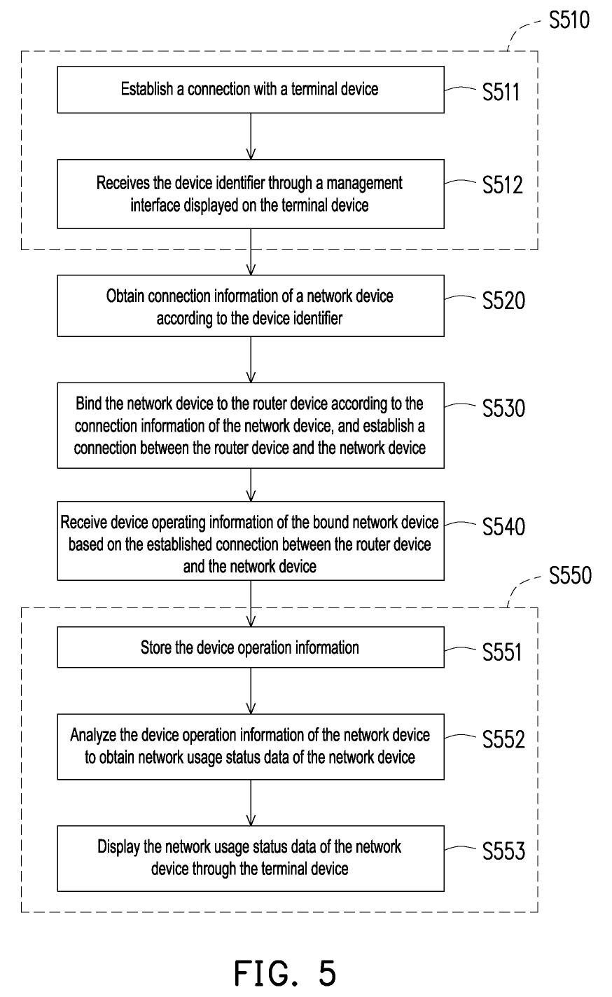

Referring to FIG. 5, which is a flowchart of a localized network management method according to an embodiment of the disclosure. Also refer to FIGS. 1 and 2, the way of this embodiment is applicable to the router device 100 of the localized network management system 10 in the above embodiment. The following will explain the detailed steps of the localized network management method of this embodiment in conjunction with the various components in the router device 100 and the localized network management system 10.

In step S510, the processor 113 receives a device identifier. In this embodiment, step S510 is implemented as steps S511 to S512. In step S511, the processor 113 establishes a connection between a terminal device T1 or terminal device T2. In step S512, the processor 113 receives the device identifier through the management interface displayed on the terminal device T1 or terminal device T2. The administrator is able to manually input the device identifier on the Web Portal displayed on the terminal device T1 or terminal device T2. Alternatively, the administrator is able to manually input the device identifier in the operation interface of the OS Utility and App displayed on the terminal device T1 or terminal device T2.

In step S520, the processor 113 obtains connection information of a network device 200_1 according to the device identifier. In step S530, the processor 113, according to the connection information of the network device 200_1, bind the network device 200_1 to the router device 100, and establish a connection between the router device 100 and the network device 200_1. In step S540, the processor 113, according to the connection between the router device 100 and the network device 200_1, receives device operation information of the bound network device 200_1. The detailed operations of the above steps S520 to S540 can be referred to in the previously described embodiment, which will not be repeated here.

In step S550, the processor 113 stores the device operation information, and perform a remote management and network control operation on the bound network device 200_1. In some embodiments, step S550 is implemented as steps S551 to S553.

In step S551, the processor 113 stores the device operation information of the network device 200_1. In step S552, the processor 113 analyzes the device operation information of the network device 200_1 to obtain network usage status data of the network device 200_1. The network usage status data comprises traffic statistics data, bandwidth utilization, network connection quality, or device load status, etc. In step S553, the processor 113 displays the network usage status data of the network device 200_1 through the terminal device T1 or terminal device T2. Specifically, in one embodiment, the terminal device T1 or terminal device T2 is the administrator's computer, mobile device, or dedicated network management platform, and the processor 113 displays the real-time operating status of the network device 200_1 through a Graphical User Interface (GUI) or Dashboard.

In some embodiments, the processor 113 adjusts QoS (Quality of Service) policies, optimize routing settings, or further perform troubleshooting analysis according to the network usage status data of the network device 200_1 to ensure the stable operation of the network device 200_1.

In some embodiments, the processor 113 also sends a real-time notification to a terminal device T1 or terminal device T2 according to the network usage status data or device operation information of the network device 200_1. In one embodiment, when the network connection quality of the network device 200_1 falls below a preset threshold, the processor 113 triggers a real-time notification to remind the administrator to perform network optimization or check potential abnormalities. Additionally, when abnormal traffic patterns are detected (such as unusually high traffic in a short period, unauthorized access, or potential network attacks), the processor 113 generates immediate alerts and display relevant information through the terminal device T1 or terminal device T2, enabling the administrator to quickly take appropriate countermeasures for the network device 200_1.

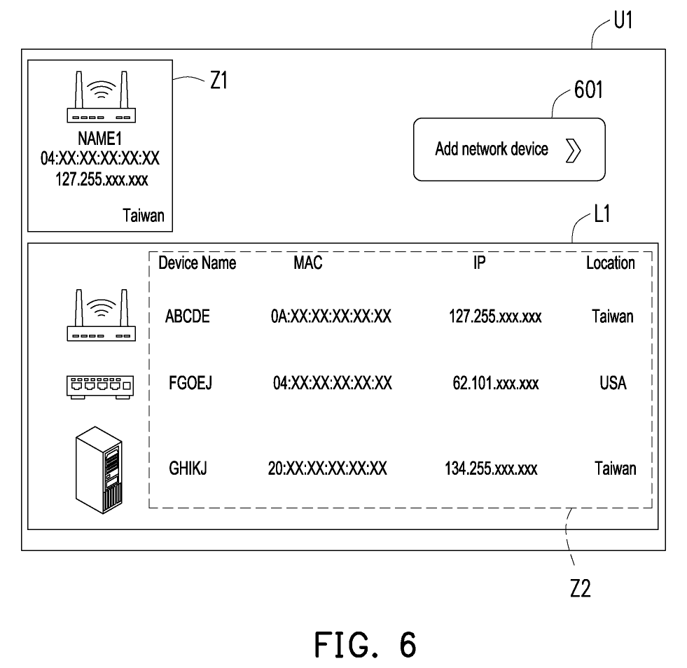

Referring to FIG. 6, which is a schematic diagram of a management interface provided by the router device according to an embodiment of the disclosure. After the administrator logs into the localized network management platform of the router device 100 using the terminal device T1 or terminal device T2 with the administrator account, the terminal device T1 or terminal device T2 displays a management interface U1. Furthermore, when the administrator connects to the router device 100 through the terminal device T1 or terminal device T2 and inputs the administrator account and authentication information (such as password, OTP, certificate verification, etc.), the processor 113 verifies the permissions of the administrator account and provide corresponding management functions according to the permission level. The management interface U1 comprises the device information Z1 of the router device 100, a management list L1, and a button 601. T he management list L1 displays the device information Z2 of multiple network devices bound to the router device 100. When the administrator clicks the button 601, another management interface for manually inputting device identifiers may be provided, allowing the administrator to add other network devices to the management list L1.

In summary, in the embodiments of the disclosure, according to the device identifier associated with the network device, the router device confirms the binding relationship between the router device itself and the network device. After establishing a connection with the network device, the router device receives device operation information from the network device and store the device operation information of the network device. Thus, the router device performs remote management and network control operations on the bound network device based on the recorded device operation information. Therefore, the device operation information of the network device does not need to be uploaded to and stored in third-party servers of the cloud management platform. Through the localized management mechanism of the router device, dependence on third-party servers of the cloud management platform can be effectively reduced, enhancing the real-time processing and privacy of data. Additionally, the embodiments of the disclosure allow the router device to quickly establish site-to-site VPN connections with multiple network devices or enable multiple network devices to quickly establish site-to-site VPN connections with each other through simple operations, which also greatly improves network management efficiency and data security.

Although the disclosure has been disclosed above in the form of exemplary embodiments, The is not intended to limit the disclosure. Anyone with ordinary knowledge in the relevant technical field may make slight changes and modifications without departing from the spirit and scope of the disclosure. Therefore, the protection scope of the disclosure shall be determined by the appended patent application scope and its equivalent scope.

What is claimed is:

1. A localized network management method, adapted to a router device, the method comprising:
receiving a device identifier;
obtaining connection information of a network device according to the device identifier;
binding the network device to the router device according to the connection information of the network device, and establishing a connection between the router device and the network device;
receiving device operation information of the bound network device according to the connection between the router device and the network device; and
storing the device operation information, and performing a remote management and network control operation on the bound network device.

2. The localized network management method as claimed in claim 1, wherein the step of obtaining the connection information of the network device according to the device identifier comprises:
obtaining the connection information of the network device when the device identifier is verified.

3. The localized network management method as claimed in claim 2, wherein the device identifier comprises a personal identifier number (PIN) code.

4. The localized network management method as claimed in claim 1, wherein the step of obtaining the connection information of the network device according to the device identifier comprises:
decoding the device identifier to obtain the connection information of the network device.

5. The localized network management method as claimed in claim 4, wherein the device identifier comprises a two-dimensional barcode.

6. The localized network management method as claimed in claim 1, wherein the step of performing the remote management and the network control operation on the bound network device comprises:
analyzing the device operation information of the network device to obtain network usage status data of the network device.

7. The localized network management method as claimed in claim 6, wherein the step of performing the remote management and the network control operation on the bound network device further comprises:
sending a real-time notification to a terminal device according to the network usage status data or the device operation information of the network device.

8. The localized network management method as claimed in claim 6, wherein the step of performing the remote management and the network control operation on the bound network device comprises:
establishing a connection with a terminal device; and
displaying the network usage status data of the network device through the terminal device.

9. The localized network management method as claimed in claim 1, wherein the step of receiving the device identifier comprises:
establishing a connection with a terminal device; and
receiving the device identifier through the management interface displayed by the terminal device.

10. A router device, comprising:
a transceiver;
a storage device; and
a processor, coupled to the transceiver and the storage device, configured to:
receive a device identifier;
obtain connection information of a network device according to the device identifier;
bind the network device to the router device according to the connection information of the network device, and establish a connection between the router device and the network device;
receive device operation information of the bound network device according to the connection between the router device and the network device; and
store the device operation information, and perform a remote management and network control operation on the bound network device.
